(19) United States
(12) Patent Application Publication
(10) Pub. No.: US 2013/0297383 A1
(43) Pub. Date: Nov. 7, 2013

(54) TEXT ANALYTICS GENERATED SENTIMENT TREE

(71) Applicants: Patrick W. Fink, Charlotte, NC (US); Kristin E. McNeil, Charlotte, NC (US); Philip E. Parker, York, SC (US)

(72) Inventors: Patrick W. Fink, Charlotte, NC (US); Kristin E. McNeil, Charlotte, NC (US); Philip E. Parker, York, SC (US)

(73) Assignee: INTERNATIONAL BUSINESS MACHINES CORPORATION, Armonk, NY (US)

(21) Appl. No.: 13/462,941

(22) Filed: May 3, 2012

(51) Int. Cl. G06Q 30/02

(52) U.S. Cl. 705/7.32

(57) ABSTRACT

Computer-implemented method, computer-program product, and system for performing an operation, the operation beginning by receiving a request for a product summary, the request identifying a product. The operation then determines, by searching a plurality of opinions, a primary characterization of a positive aspect of the product and a primary characterization of a negative aspect of the product. The operation then determines, by searching the plurality of opinions, a secondary characterization of at least one of the positive aspect and the negative aspect of the product. The operation then generates a product summary for the identified product, wherein the product summary identifies the product and includes the primary characterization of the positive aspect, the primary characterization of the negative aspect, and the secondary characterization. The operation then outputs the generated product summary responsive to the request for the product summary.

### BACKGROUND

Embodiments disclosed herein relate to the field of computer software. More specifically, embodiments disclosed herein relate to generating a sentiment tree by analyzing the text of user opinions.

### SUMMARY

Embodiments disclosed herein provide a computer-implemented method, computer-program product, and system for performing an operation that includes receiving a request for a product summary, the request identifying a product. The operation then determines, by searching a plurality of opinions, a primary characterization of a positive aspect of the product and a primary characterization of a negative aspect of the product. The operation then determines, by searching the plurality of opinions, a secondary characterization of at least one of the positive aspect and the negative aspect of the product. The operation then generates a product summary for the identified product, wherein the product summary identifies the product and includes the primary characterization of the positive aspect, the primary characterization of the negative aspect, and the secondary characterization. The operation then outputs the generated product summary responsive to the request for the product summary.

### BRIEF DESCRIPTION OF THE DRAWINGS

So that the manner in which the above recited aspects are attained and can be understood in detail, a more particular description of embodiments of the disclosure, briefly summarized above, may be had by reference to the appended drawings.

It is to be noted, however, that the appended drawings illustrate only typical embodiments of this disclosure and are therefore not to be considered limiting of its scope, for the disclosure may admit to other equally effective embodiments.

FIG. 1 is a block diagram illustrating a system for generating a sentiment tree by analyzing the text of user opinions, according to one embodiment described herein.

FIG. 2 is a flow chart illustrating a method for generating a sentiment tree by analyzing the text of user opinions, according to one embodiment described herein.

FIG. 3 is a flow chart illustrating a method for generating a sentiment tree, according to one embodiment disclosed herein.

FIG. 4 is a block diagram illustrating an exemplary sentiment tree, according to one embodiment disclosed herein.

### DETAILED DESCRIPTION

Embodiments disclosed herein provide a computer-implemented method, computer-program product, and system for performing an operation that includes receiving a request for a product summary, the request identifying a product. The operation then determines, by searching a plurality of opinions, a primary characterization of a positive aspect of the product and a primary characterization of a negative aspect of the product. The operation then determines, by searching the plurality of opinions, a secondary characterization of at least one of the positive aspect and the negative aspect of the product. The operation then generates a product summary for the identified product, wherein the product summary identifies the product and includes the primary characterization of the positive aspect, the primary characterization of the negative aspect, and the secondary characterization. The operation then outputs the generated product summary responsive to the request for the product summary.

Most businesses sell products, goods, or services to customers (collectively referred to hereinafter as “products”). In an effort to gain a competitive advantage over their competitors, many business attempt to understand the sentiment of their customer and consumer base. With the proliferation of the Internet, consumers can now post reviews, blogs, messages, or other text write-ups (collectively referred to hereinafter as “opinions”) related to the products that they have purchased. In these opinions, consumers can make positive and negative characterizations of the products, which can be tied to consumer sentiment. A characterization may be one or more words expressing user sentiment or opinion about a particular product.

The statements that customers make regarding their experiences with a product hold valuable insight into the customer's opinions regarding the product, and may even uncover product flaws or defects. Often, an opinion will contain multiple sentiments and even suggestions for correcting or improving products. The ability to generate a visualization of the consumer's sentiments for the products by analyzing the opinions they write would save businesses time and money by identifying and correcting issues that customers care about. Based on consumer sentiments, business could modify and improve their products, or the method by which they are presented or delivered to the consumer, which could potentially result in higher sales and profits.

Embodiments disclosed herein use text analytics to determine the positive and negative sentiment in a collection of user opinions based on a search term. Embodiments disclosed herein then utilize the sentiment to output results and display them in a tree format. The outputted tree has the search term set as the root node, with the most negative and most positive sentiment term is displayed as the child nodes, along with the number of opinions in which the sentiment terms appear. The tree format allows the user to easily see the network of associated positive and negative terms based on a given search term.

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications for generating sentiment trees or related data available in the cloud. For example, the application for generating sentiment trees could execute on a computing system in the cloud and generate a sentiment tree capturing user sentiment about a product or service. In such a case, the application could generate the sentiment tree and store the sentiment tree at a storage location in the cloud. Doing so allows a user to access this information from any computing system attached to a network connected to the cloud (e.g., the Internet).

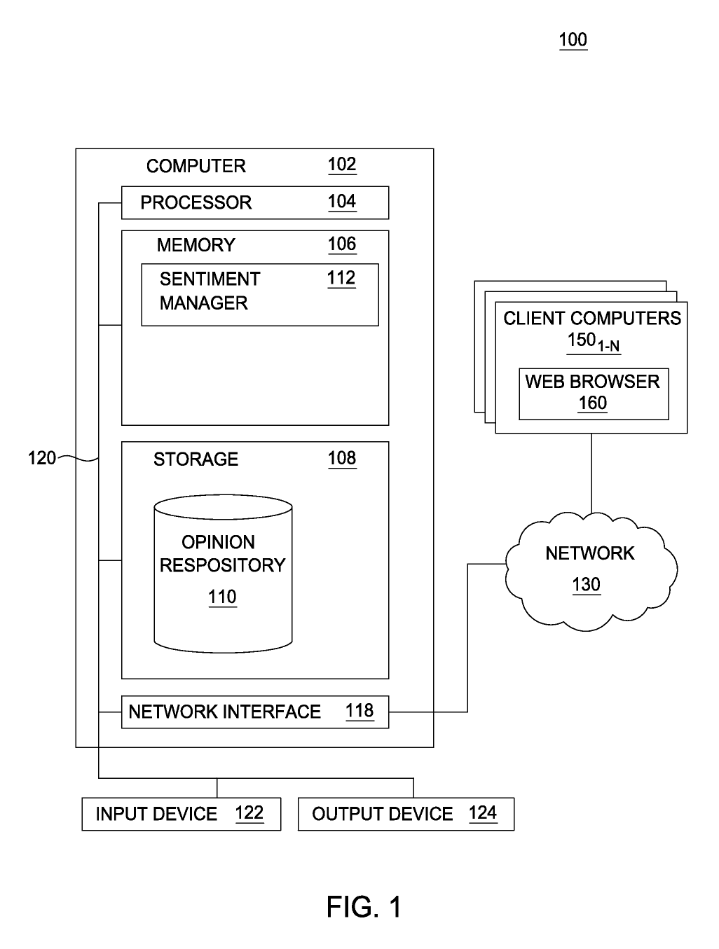

FIG. 1 is a block diagram illustrating a system 100 for generating a sentiment tree by analyzing the text of user opinions. The networked system 100 includes a computer 102. The computer 102 may also be connected to other computers via a network 130. In general, the network 130 may be a telecommunications network and/or a wide area network (WAN). In a particular embodiment, the network 130 is the Internet.

The computer 102 generally includes a processor 104 connected via a bus 120 to a memory 106, a network interface device 118, a storage 108, an input device 122, and an output device 124. The computer 102 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used. The processor 104 is included to be representative of a single CPU, multiple CPUs, a single CPU having multiple processing cores, and the like. Similarly, the memory 106 may be a random access memory. While the memory 106 is shown as a single identity, it should be understood that the memory 106 may comprise a plurality of modules, and that the memory 106 may exist at multiple levels, from high speed registers and caches to lower speed but larger DRAM chips. The network interface device 118 may be any type of network communications device allowing the computer 102 to communicate with other computers via the network 130.

The storage 108 may be a persistent storage device. Although the storage 108 is shown as a single unit, the storage 108 may be a combination of fixed and/or removable storage devices, such as fixed disc drives, solid state drives, floppy disc drives, tape drives, removable memory cards or optical storage. The memory 106 and the storage 108 may be part of one virtual address space spanning multiple primary and secondary storage devices.

As shown, the memory 106 contains sentiment manager 112, which is an application generally configured to generate a tree displaying user sentiment about a particular product by analyzing the text of a plurality of opinions about the product. As shown, storage 108 contains opinion repository 110, which stores user opinions relating to a plurality of products. Although depicted as a database, the opinion repository 110 may take any form sufficient to store the text of user opinions, including text files, xml data files, and the like. In some embodiments, the opinions in the opinion repository 110 are received from a plurality of client computers 150_{1-N}. As shown, the client computers 150_{1-N} contain a web browser 160 which is used to submit opinions to the opinion repository 110. In other embodiments, the sentiment manager 112 may retrieve the opinions from a plurality of sources and store them in the opinion repository 110. In some embodiments, the opinion repository 110 may be a set of text files in a directory, which are loaded by the sentiment manager 112. In other embodiments, the opinions may be loaded directly into the opinion repository 110. In some embodiments disclosed herein, the sentiment manager 112 may search opinions stored in the opinion repository 110 to generate a sentiment tree based on a user-defined search term relating to a product.

The input device 122 may be any device for providing input to the computer 102. For example, a keyboard and/or a mouse may be used. The output device 124 may be any device for providing output to a user of the computer 102. For example, the output device 124 may be any conventional display screen or set of speakers. Although shown separately from the input device 122, the output device 124 and input device 122 may be combined. For example, a display screen with an integrated touch-screen may be used.

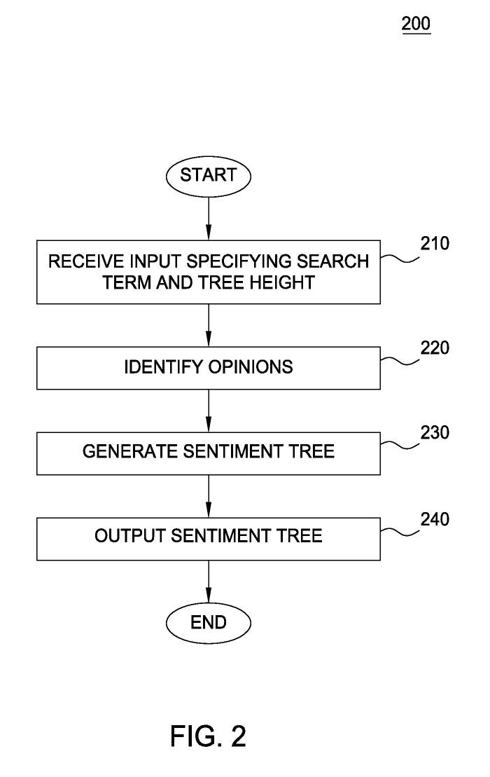

FIG. 2 is a flow chart illustrating a method 200 for generating a sentiment tree by analyzing the text of user opinions, according to one embodiment described herein. In some embodiments, the sentiment manager 112 performs the steps of the method 200. At step 210, the sentiment manager 112 receives input specifying one or more search terms and a tree height. In some embodiments, the search term may correspond to a particular product or service, such as “baseball bat,” or “house painter.” The height of the sentiment tree corresponds to the desired number of levels of the tree generated by the sentiment manager 112. A “level” as used herein indicates a generation of child nodes originating from a parent node. In some embodiments, a default tree height may be provided by the sentiment manager 112, which may be replaced by a tree height inputted by the user. At step 220, the sentiment manager 112 identifies the opinions which will be searched to discover the consumer sentiment. In some embodiments, the opinions are stored in the opinion repository 110, and the sentiment manager 112 identifies the opinions by connecting to the opinion repository 110. As discussed above, the opinions may take any form suitable for expressing user sentiment, including, but not limited to, reviews, blog posts, articles, messages, and the like. An opinion may include both positive and negative sentiment. At step 230, the sentiment manager 112 generates a sentiment tree based on the search term and an analysis of the text found in the opinions. At step 240, the sentiment manager outputs the sentiment tree generated at step 230.

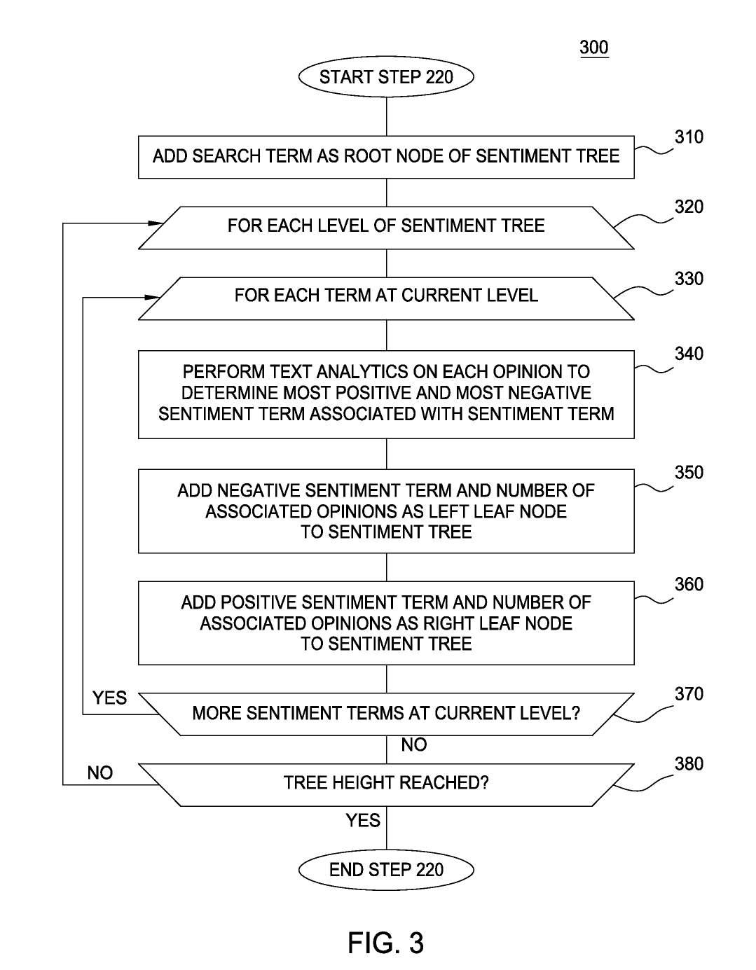

FIG. 3 is a flow chart illustrating a method 300 corresponding to step 230 for generating a sentiment tree, according to one embodiment disclosed herein. In some embodiments, the sentiment manager 112 performs the steps of the method 300. At step 310, the sentiment manager 112 adds the search term as the root node of the sentiment tree. At step 320, the sentiment manager 112 executes a loop containing steps 330-380 for generating each level of the sentiment tree, until the user-specified height has been reached. At step 330, the sentiment manager 112 executes a loop containing steps 340-370 for each term at the current level of the sentiment tree. During the first iteration of the loop, the sentiment manager 112 operates on the user-provided search term. In subsequent iterations, the sentiment manager 112 operates on the sentiment terms forming the child nodes at the current tree level. At step 340, the sentiment manager 112 performs text analytics on each opinion to determine the most positive and the most negative sentiment term associated with the current term. For example, if the user-supplied search terms are “ACME anvils,” the sentiment manager 112 will perform a search of all opinions in the opinion repository 110 to determine the most positive and the most negative terms associated with “ACME anvils.” In some embodiments, the sentiment manager 112 analyzes the text of the opinions and their context in order to determine which terms are negative, and which are positive. In some other embodiments, a list of predefined positive and negative sentiment terms may be stored in the opinion repository 110, which the sentiment manager 112 may reference in order to identify positive and negative sentiment terms. In some other embodiments, the sentiment manager 112 may detect capitalization or punctuation patterns which indicate sentiment. In some embodiments, while conducting a search of the opinions in opinion repository 110, the sentiment manager 112 may also compute a count of the number of opinions in which the search term appears. In some embodiments, the sentiment manager 112 determines the most positive and most negative sentiment terms in the opinions by identifying the positive and negative terms having the highest count totals in the opinions. An exemplary positive sentiment term related to “ACME anvils” returned by the sentiment manager 112 may be “well built.” An exemplary negative sentiment term returned by the sentiment manager 112 may be “ineffective in crushing roadrunners.” As shown, the search terms and positive and negative sentiments may be one word, or a plurality of words.

At step 350, the sentiment manager 112 adds the most negative sentiment term and the number of associated opinions as the left leaf node of the term currently being searched. Therefore, in the above example, “ineffective in crushing roadrunners” and the computed count would be added as the left child of the root node “ACME anvils.” At step 360, the sentiment manager 112 adds the most positive sentiment term and the number of associated opinions as the right child node of the term currently being searched. Therefore, in the above example, “well built” and the computed count would be added as the right child of the root node “ACME anvils.” It is contemplated that the most positive sentiment term and the most negative sentiment term may be either the right or left child of the parent node, so long as consistency is maintained throughout the tree. At step 370, the sentiment manager 112 determines whether more terms remain at the current level. If more terms at the current level remain, the sentiment manager 112 returns to step 330. Otherwise, the sentiment manager 112 proceeds to step 370. At step 380, the sentiment manager 112 determines whether the user-specified tree height has been reached. If the tree height has been reached, the tree is complete, and the method 300 ends. If the tree height has not been reached, the sentiment manager 112 returns to step 320, where another level of terms will be processed.

Continuing the above example using the root node, there would be one iteration of the loop from steps 330-370 for the original search term “ACME anvils,” as there is only the root node at the first level of the sentiment tree. If the user specified a tree height of 3, there would be subsequent iterations of each loop. The next iteration of the loop comprising steps 320-380 would then be executed for the second level of the tree, and the loop comprising steps 330-370 would be executed once each for the positive and negative sentiment terms “well built” and “ineffective for crushing roadrunners,” each of which appears on the second level of the tree. Therefore, a most positive and most negative sentiment term would be determined for “well built” and “ineffective in crushing roadrunners,” and placed as respective child nodes in the tree.

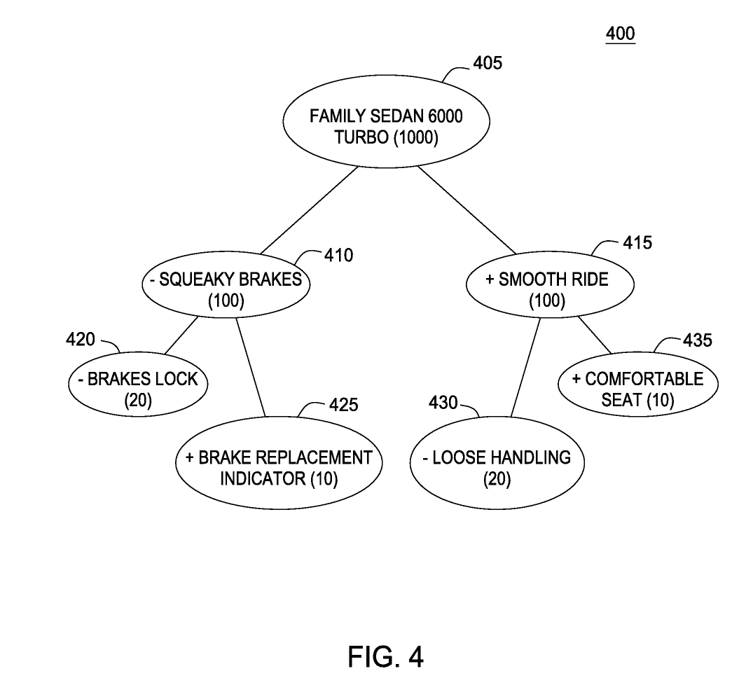

FIG. 4 is a block diagram illustrating an exemplary sentiment tree 400, according to one embodiment disclosed herein. As shown, the sentiment tree 400 has three levels, which in some embodiments corresponds to user input specifying a tree height of three. As shown, the sentiment tree 400 contains root node 405, which contains the user-supplied search term of “Family Sedan 6000 Turbo.” The value of (1000) indicates that there were 1,000 opinions in the opinion repository 110 which included the search term “Family Sedan 6000 Turbo.” The node 410, which is the left child of the root node 405, indicates the most negative sentiment term corresponding to “Family Sedan 6000 Turbo.” As shown, the node 410 contains the term “Squeaky Brakes,” along with a corresponding count of 100 and a minus sign to indicate negative sentiment. The node 415 is the right child of the root node 405, and indicates the most positive sentiment term corresponding to “Family Sedan 6000 Turbo.” As shown, the node 415 is labeled as “Smooth Ride,” which has a count of 110 and a plus sign to indicate the positive sentiment. The node 420 is the left child of the node 410, and indicates the most negative sentiment term for “Squeaky Brakes.” As shown, the label of node 420 is “Brakes Lock,” which appeared 20 times in the search of the opinion repository 110. The node 425 is the right child of the node 410, and indicates the most positive sentiment corresponding to “Squeaky Brakes.” As shown, node 425 is labeled as “Brake Replacement Indicator” which was found in 10 opinions in the opinion repository 110. The node 430 is the left child of the node 415, and indicates the most negative sentiment term for the term “Smooth Ride.” As shown, the text of node 430 is “Loose Handling,” which appeared 20 times in the search of the opinion repository 110. The node 435 is the right child of the node 415, and indicates the most positive sentiment corresponding to “Smooth Ride.” As shown, the node 435 is labeled as “Comfortable Seat” which was found in 10 opinions in the opinion repository 110.

By analyzing the tree 400, the maker of the “Family Sedan 6000 Turbo” can determine a number of things about the car through the consumer sentiment in the form of the characterizations in the consumer opinions. For example, the automaker may determine that, as shown in node 410, squeaky brakes are the most frequently occurring negative primary characterization of the vehicle. Scanning further down the tree, the automaker may determine at node 420 that locking brakes is the most negative secondary characterization of the squeaky brakes. Based on this sentiment, the automaker may determine that the brakes on the vehicle need to be reexamined and improved. However, the automaker, by examining the node 425, may notice the positive secondary characterizations about the brake replacement indicator, and decide to retain the brake replacement indicator even if the brakes are improved. Returning to node 415, the automaker may determine that a smooth ride is the most positive primary characterization of the vehicle, but that the vehicle may also suffer from loose handling, as shown in node 430. The automaker may therefore put additional efforts into improving the handling of the vehicle. Finally, the automaker, by examining node 435, may realize that there is a positive secondary characterization related to the seat comfort. If, for example, the automaker was devoting time and resources to improve the seat, the automaker may cease its efforts in improving the seats and focus its efforts on improving another aspect of the car.

By generating a tree in the above described fashion, the sentiment of a customer base can be quickly determined and presented in an easily consumable format via the sentiment tree. In addition, the most positive and the most negative sentiment for a given term may be presented as child nodes in the tree structure. Therefore, the additional added benefit of displaying positive and negative sentiment related to positive and negative sentiment terms themselves may be attained. By recursively searching the customer opinions, a tree of any desired height may be generated to capture the sentiment at each level. A tree presented in such a format may allow organizations to make better and more informed decisions as to their products and services, improve customer relations, and increase overall sales and profits.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A computer-implemented method for programmatically generating a product summary based on a plurality of opinions, comprising:
receiving a request for a product summary, the request identifying a product;
determining, by searching a plurality of opinions, a primary characterization of a positive aspect of the product and a primary characterization of a negative aspect of the product;
determining, by searching the plurality of opinions, a secondary characterization of at least one of the positive aspect and the negative aspect of the product;
generating, by operation of one or more computer processors, a product summary for the identified product, wherein the product summary identifies the product and includes the primary characterization of the positive aspect, the primary characterization of the negative aspect, and the secondary characterization; and
outputting the generated product summary responsive to the request for the product summary.

2. The method of claim 1, further comprising generating a sentiment tree based on the plurality of opinions, wherein the product summary is generated based on the sentiment tree.

3. The method of claim 1, wherein the determined characterizations are selected from a plurality of characterizations based on a count of opinions in which the respective characterization occurs.

4. The method of claim 1, wherein the product summary further includes a count of opinions in which at least one of the determined characterizations occurs.

5. The method of claim 1, wherein the product is one of a good and a service for which a product summary is desired.

6. The method of claim 1, wherein the request specifies a desired count of characterizations of at least one of the positive aspect and the negative aspect of the product.

7. The method of claim 1, wherein the secondary characterization of the positive aspect negatively characterizes the positive aspect.

8. A computer program product for programmatically generating a product summary based on a plurality of opinions, the computer program product comprising:
a computer-readable storage medium having computer-readable program code embodied therewith, the computer-readable program code comprising:
computer-readable program code configured to receive a request for a product summary, the request identifying a product;
computer-readable program code configured to determine, by searching a plurality of opinions, a primary characterization of a positive aspect of the product and a primary characterization of a negative aspect of the product;
computer-readable program code configured to determine, by searching the plurality of opinions, a secondary characterization of at least one of the positive aspect and the negative aspect of the product;
computer-readable program code configured to generate a product summary for the identified product, wherein the product summary identifies the product and includes the primary characterization of the positive aspect, the primary characterization of the negative aspect, and the secondary characterization; and
computer-readable program code configured output the generated product summary responsive to the request for the product summary.

9. The computer-program product of claim 8, further comprising computer-readable program code configured to generate a sentiment tree based on the plurality of opinions, wherein the product summary is generated based on the sentiment tree.

10. The computer-program product of claim 8, wherein the determined characterizations are selected from a plurality of characterizations based on a count of opinions in which the respective characterization occurs.

11. The computer-program product of claim 8, wherein the product summary further includes a count of opinions in which at least one of the determined characterizations occurs.

12. The computer program product of claim 8, wherein the product is one of a good and a service for which a product summary is desired.

13. The computer program product of claim 8, wherein the request specifies a desired count of characterizations of at least one of the positive aspect and the negative aspect of the product.

14. A system, comprising:
one or more computer processors;
a memory containing a program, which, when executed by the one or more computer processors, performs an operation for programmatically generating a product summary based on a plurality of opinions, the operation comprising:
receiving a request for a product summary, the request identifying a product;
determining, by searching a plurality of opinions, a primary characterization of a positive aspect of the product and a primary characterization of a negative aspect of the product;
determining, by searching the plurality of opinions, a secondary characterization of at least one of the positive aspect and the negative aspect of the product;
generating, by operation of one or more computer processors, a product summary for the identified product, wherein the product summary identifies the product and includes the primary characterization of the positive aspect, the primary characterization of the negative aspect, and the secondary characterization; and
outputting the generated product summary responsive to the request for the product summary.

15. The system of claim 14, the operation further comprising generating a sentiment tree based on the plurality of opinions, wherein the product summary is generated based on the sentiment tree.

16. The system of claim 14, wherein the determined characterizations are selected from a plurality of characterizations based on a count of opinions in which the respective characterization occurs.

17. The system of claim 14, wherein the product summary further includes a count of opinions in which at least one of the determined characterizations occurs.

18. The system of claim 14, wherein the product is one of a good and a service for which a product summary is desired.

19. The system of claim 14, wherein the request specifies a desired count of characterizations of at least one of the positive aspect and the negative aspect of the product.

20. The system of claim 14, wherein the secondary characterization of the positive aspect negatively characterizes the positive aspect.
